(19) United States
(12) Patent Application Publication
(10) Pub. No.: US 2005/0034745 A1
(43) Pub. Date: Feb. 17, 2005

(54) Processing a workpiece with ozone and a halogenated additive

(75) Inventors: Eric J. Bergman, Kalispell, MT (US); Brian Aegerter, Kalispell, MT (US); Mark Herron, Kalispell, MT (US)

Correspondence Address: PERKINS COIE LLP, POST OFFICE BOX 1208, SEATTLE, WA, 98111-1208, US

(73) Assignee: Semitool, Inc.

(21) Appl. No.: 10/917,094

(22) Filed: Aug. 11, 2004

Related U.S. Application Data
(63) Continuation-in-part of application No. 09/621,028, filed on Jul. 21, 2000.
Application No. 09/621,028 is a continuation-in-part of application No. PCT/US99/08516, filed on Apr. 16, 1999.
Application No. PCT/US99/08516 is a continuation-in-part of application No. 09/061,318, filed on Apr. 16, 1998, now abandoned.
Application No. 09/061,318 is a continuation-in-part of application No. 08/853,649, filed on May 9, 1997, now Pat. No. 6,240,933.

(51) Int. Cl. B08B 3/00

(52) U.S. Cl. 134/26; 134/33; 134/151; 134/137; 134/198

(57) ABSTRACT

In a process for removing an anti-reflective coating, a workpiece such as a semiconductor wafer is placed in a support in a process chamber. A heated liquid including a halogenated additive is applied onto the workpiece, forming a liquid layer on the workpiece. The thickness of the liquid layer is controlled. Ozone is introduced into the process chamber by injection into the liquid or directly into the process chamber. Ozone oxidizes and removes the film on the workpiece. The methods are especially useful for anti-reflective coating or sacrificial light absorbing layers.

This Application is a Continuation of U.S. Patent Application Ser. No. 09/621,028, filed Jul. 21, 2000 and now pending, which is a Continuation-in-Part of International Patent Application PCT/US99/08516, filed Apr. 16, 1999, which is a Continuation-in-Part of U.S. patent application Ser. No. 09/061,318, filed Apr. 16, 1998, and now abandoned, which is a Continuation-in-Part of U.S. patent application Ser. No. 08/853,649, filed May 7, 1997, and now U.S. Pat. No. 6,240,933. Priority to each of these Applications is claimed under 35 U.S.C. §§ 119 and 120. These applications are also incorporated herein by reference.

Semiconductor devices are widely used in almost all consumer and home electronic products, as well as in communications, medical, industrial, military, and office products and equipment. Semiconductor devices are manufactured from semiconductor wafers. The wafers are typically round, flat silicon disks. The cleaning of semiconductor wafers is often a critical step in the fabrication processes used to manufacture semiconductor devices. The electronic devices formed on wafers are often just fractions of a micron. This makes these microelectronic devices highly susceptible to performance degradation or even complete failure due to contamination by organic, metal, or other particles. Various types of films or coatings are generally applied to the wafers at various stages of manufacturing. However, these films must be removed before subsequent manufacturing steps take place. Consequently, cleaning the wafers, to remove contamination or films, is often a critical step in the manufacturing process.

For many years, wafers were cleaned in typically three or four separate steps using strong acids, such as sulfuric acid, and/or using strong caustic solutions, such as mixtures of hydrogen peroxide or ammonium hydroxide. Organic solvents have also been used with wafers having metal films. While these methods performed well, they had certain disadvantages, including the high cost of the process chemicals, the relatively long time required to get wafers through the various cleaning steps, high consumption of water due to the need for extensive rinsing between chemical steps, and high disposal costs. As a result, extensive research and development efforts have focused on finding better wafer cleaning techniques.

More recently, the semiconductor manufacturing industry has acknowledged a revolutionary new process for cleaning wafers using ozone. In this new process, ozone gas is provided into the process chamber and moves through a thin layer of heated water on the wafers, via diffusion and/or bulk transport. This ozone gas process has proven to be highly effective in cleaning contamination and organic films off of wafers, while avoiding many of the disadvantages of the older methods using acids and caustics. The advantages of the ozone process are that is it fast, requires no expensive and toxic liquid acids or caustics, and operates effectively as a spray process, which greatly reduces water consumption and space requirements.

The ozone gas cleaning process can be performed in various ways. These include spraying water onto the wafer or workpiece while injecting ozone into the water, spraying water on the workpiece while delivering ozone to the workpiece, delivering a combination of steam or water vapor and ozone to the workpiece, and applying water, ozone, and sonic energy simultaneously to the workpiece. Spray techniques using water at elevated temperatures have been especially successful at increasing the removal rates of various organic films and contaminants from workpiece surfaces.

Notwithstanding its remarkable success in many applications, there are some films that can be more resistant to removal using the ozone methods. These films include anti-reflective coatings (ARC), such as sacrificial light absorbing coatings or films (SLAM) and DUO™ coating manufactured by Honeywell Electronic Materials, Sunnyvale, Calif. 94089, USA. These and similar coatings and/or films, collectively referred to here as “ARC”, while more difficult to remove or clean away, are advantageously used in photolithography steps during the manufacture of certain semiconductor products. However, after these photolithography and/or related steps are performed, the ARC film must be removed before the manufacturing process can continue. Accordingly, there is a need for better equipment and methods for removing ARC films and similar films.

Other types of films or contaminants, such as organic materials, metals, silicon dioxide, and particulates, can also present obstacles during cleaning steps. Accordingly, there is a need for improved methods for cleaning or processing workpieces using the ozone and heated water techniques.

### SUMMARY OF THE INVENTION

After extensive research, the inventors have now discovered contaminants and films which are not easily removed with ozone and heated water methods, can very effectively be removed in a new process using ozone, heated water and a halogenated additive. Surprisingly, although ozone and heated water alone cannot remove these types of films, and although a halogenated additive alone cannot remove these types of films, when used together, the combination of ozone, heated water and the halogenated additive can quickly and completely remove them.

In one aspect, a method for processing a workpiece includes introducing a heated liquid including a halogenated additive onto the surface of the workpiece. The heated liquid forms a liquid layer on the workpiece. Ozone is provided around the workpiece. The thickness of the liquid on the surface of the workpiece is controlled. The heated liquid, halogenated additive and the ozone act to effectively remove contaminants or films.

In other separate aspects, the liquid is or includes water, the halogenated additive is HF, the concentration of ozone and halogenated additive are selected to avoid allowing the surface of the workpiece to become hydrophobic, or the thickness of the liquid layer is controlled by spinning the workpiece, and/or by controlling the flow rate of the liquid onto the workpiece. These aspects may be used alone or in combinations with each other.

In an additional aspect, the workpiece is rotated in a process chamber. A heated liquid including a halogenated additive is sprayed onto a film on the workpiece, with the heated liquid forming a liquid layer covering the film. Ozone is provided into the chamber. The thickness of the liquid layer is controlled or maintained, to allow diffusion of the ozone through the liquid layer. The film or anti-reflective coating is removed from the surface of the workpiece via a chemical reaction between the halogenated additive in the water, the ozone and the ARC.

In an immersion process, water containing a halogenated additive is heated. A workpiece is immersed into a bath of the heated water. Ozone gas is introduced into the heated water. The ARC film or coating is removed from the surface of the workpiece via a chemical reaction.

The invention resides as well in subcombinations of the apparatus and methods described. It is an object of the invention to provide improved methods and apparatus for cleaning and processing workpieces.

### BRIEF DESCRIPTION OF THE DRAWINGS

In the drawings, wherein the same reference number indicates the same element throughout the several views:

FIG. 1 is a schematic diagram of an apparatus for cleaning or processing a workpiece, such as a semiconductor wafer, with ozone injected or bubbled into the water or liquid including a halogenated additive.

FIG. 2 is a flow diagram illustrating steps for process for cleaning or processing a workpiece using water or a liquid, a halogenated additive and ozone.

FIG. 3 is a schematic diagram of an apparatus for cleaning or processing a workpiece using water or a liquid, a halogenated additive and ozone, with the ozone supplied into the processing chamber, rather than into the liquid as shown in FIG. 1.

FIG. 4 is a schematic diagram of an apparatus for cleaning or processing a workpiece using steam, a halogenated additive and ozone.

FIG. 5 is a schematic diagram of an apparatus similar to the apparatus of FIG. 3, wherein liquid including a halogenated additive is applied to the workpiece in the form of a high pressure jet.

While showing preferred designs, the drawings include elements which may or may not be essential to the invention. The elements essential to the invention are set forth in the claims. Thus, the drawings include both essential and non-essential elements.

### DETAILED DESCRIPTION OF THE DRAWINGS

A workpiece or wafer is defined here to include a workpiece formed from a substrate upon which microelectronic circuits or components, data storage elements or layers, and/or micro-mechanical or micro-electro-mechanical elements are formed. The apparatus and methods described here may be used to clean or process workpieces such as semiconductor wafers or articles, as well as other workpieces or objects such as flat panel displays, hard disk media, CD glass, memory media, MEMs devices, optical media or masks, etc.

In one of the basic forms of the invention, a halogenated additive solution, such as a dilute mixture of hydrofluoric acid (HF) in water, is heated to an elevated temperature and is applied to the workpiece surface. A layer of the dilute liquid mixture is formed on the surface. Ozone gas is simultaneously provided into the process chamber. The ozone is entrained in and diffuses through the liquid layer and oxidizes the underlying contaminant material or film. The halogenated additive helps to enable and/or expedite the removal of contaminants or films. As applied specifically to removing ARC films, experimental testing shows that dilute halogenated additive alone, and ozone and water alone, will not remove ARC films. However, it has now been discovered that using heated water, a halogenated additive and ozone diffusing through a layer of the water on the workpiece, is suprisingly effective in removing films such as ARC films. The terms film, coating and contaminant, may be used interchangeably here, to mean a substance on the workpiece which is removed by the processes described. The ozone may be dissolved or entrained in the liquid.

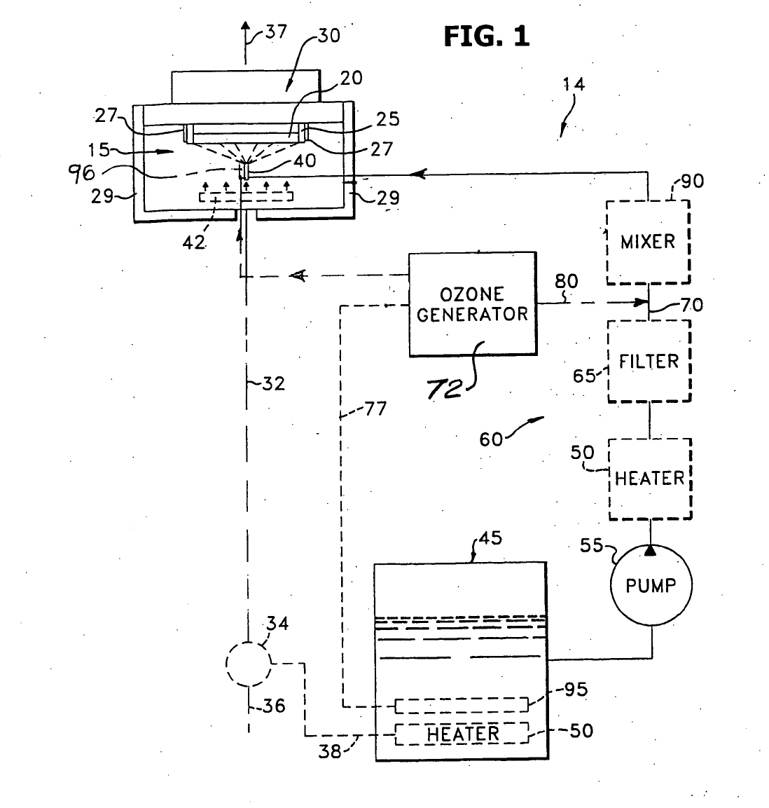

Although the apparatus is illustrated for use in single wafer processing, the apparatus and methods of FIGS. 1-5 may also be used on a batch of workpieces. Thus, all references to a single workpiece 20 are directed to multiple workpieces as well.

Turning now to FIG. 1, in a processing or cleaning system 14, a workpiece 20 is preferably supported within a processing chamber 15 by one or more supports 25 extending from, for example, a rotor assembly 30. A chamber door closes off or optionally also seals the chamber 15. The rotor assembly 30 spins the workpiece 20 about a spin axis 37 during and/or after processing with ozone, HF and a process liquid. Alternatively, a stationary fixture may be used in the chamber 15 for non-spinning methods.

The volume of the processing chamber 15 is preferably minimized. The processing chamber 15 is preferably cylindrical for processing multiple workpieces or wafers in a batch. A disk-shaped chamber is advantageously used for single wafer processing. Typically, the chamber volume will range from about 5 liters (for a single wafer) to about 50 liters (for a 50 wafer system).

Referring still to FIG. 1, one or more nozzles 40 are preferably disposed within the processing chamber 15 to direct a spray mixture of ozone and liquid onto one or both surfaces of the workpiece 20. The liquid may also be applied in other ways besides spraying, such as flowing, bulk deposition, immersion, condensation, etc.

Process liquid including a halogenated additive, and ozone may be supplied to the nozzles 40 by a fluid line carrying the gas mixed with the liquid. A reservoir 45 or tank preferably holds the liquid. The reservoir 45 is preferably connected to the input of a pump 55. The pump 55 provides the liquid under pressure along a fluid flow path generally designated as 60, for supply to the nozzles 40. While use of a reservoir 45 is preferred, any liquid source may be used, including a pipeline.

As shown in FIG. 1, one or more heaters 50 in the liquid flow path may be used to heat the process liquid. An in-line heater, or a tank heater, or both, may be used, as shown in FIG. 1. For processes at ambient or room temperatures, the heater 50 can be omitted. The liquid flow path 60 may optionally include a filter 65 to filter out microscopic contaminants from the process liquid. The process liquid, still under pressure, is provided at the output of the filter 65 (if used) along fluid flow line 70.

In the embodiment illustrated in FIG. 1, ozone is injected into the flow line 70. The ozone is generated by an ozone generator 72 and is supplied along an ozone supply line 80, under at least nominal pressure, to the fluid flow line 70. The halogenated additive, such as HF is preferably added to the liquid, or dissolved into the liquid, before the liquid is supplied into the tank 45. Alternatively, the halogenated additive can be mixed with the liquid in the tank 45. Optionally, the liquid and halogenated additive solution, now injected with ozone, is supplied to the input of a mixer 90 that mixes the ozone and the process liquid. The mixer 90 may be static or active. From the mixer 90, the process liquid carrying the ozone flows to the nozzles 40. The nozzles 40 spray the liquid onto the surface of the workpiece 20 to be cleaned or processed, and also introduce the ozone into the environment of the processing chamber 15. As an alternative to mixing, the ozone and may be entrained in the liquid before the liquid is sprayed onto the workpiece 20. The mixer 90 may be omitted.

Referring still to FIG. 1, to further concentrate the ozone in the process liquid, an output line 77 of the ozone generator 72 may supply ozone to a dispersion unit 95 in the reservoir 45. The dispersion unit 95 provides a dispersed flow of ozone through the process liquid before injection of the gas into the fluid path 60. The dispersion unit 95 may also be omitted.

In the embodiment illustrated in FIG. 1, used liquid in the processing chamber 15 is optionally collected and drained via a fluid line 32 to a valve 34. The valve 34 may be operated to provide the spent liquid to either a drain outlet 36 or back to the reservoir 45 via a recycle line 38. Repeated cycling of the process liquid through the system and back to the reservoir 45 assists in elevating the ozone concentration in the liquid through repeated injection and/or dispersion. The spent liquid may alternatively be directed from the processing chamber 15 to a waste drain. The workpieces may also be heated directly, via optional heating elements 27 in the chamber, or via a chamber heater 29 for heating the chamber and indirectly heating the workpiece 20.

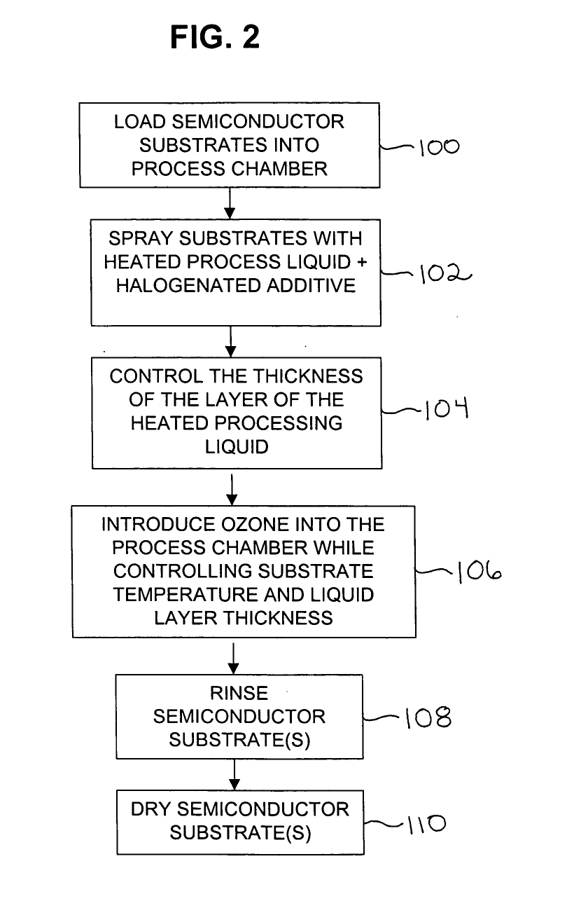

FIG. 2 illustrates a process that may be carried out in the system of FIG. 1, for example, to clean a workpiece having ARC film. At step 100, the workpiece(s) 20 is placed in, for example, a holding fixture on the rotor assembly 30. For batch processing, a batch of workpieces 20 may be placed into a wafer cassette or other carrier, for processing in a stand alone processor, such as in Ser. No. 10/654,859, or in an automated system, for example, as described in U.S. Pat. Nos. 6,447,232; or 5,660,517, and Ser. No. 09/612,009, all incorporated herein by reference. Alternatively, the workpieces 20 may be placed into the processing chamber 15 in a carrierless manner, using an automated processing system, such as that described in U.S. Pat. Nos. 5,784,797 or 6,279,724, both incorporated herein by reference.

The holding fixture or cassette, if used, is placed in a closed environment, such as in the processing chamber 15. At step 102, heated deionized water including a halogenated additive is sprayed onto the surfaces of the workpiece 20. The heated deionized water heats the workpiece 20. The boundary layer of deionized water (i.e. the thickness of the layer of water on the workpiece) is controlled at step 104 using one or more techniques. For example, the workpiece 20 may be rotated about axis 37 by the rotor 30 (at e.g., 0-5000 rpm; or 200-4000 rpm; or 500-2500 rpm) to generate centrifugal forces that thin the boundary layer. The flow rate of the deionized water may also be used to control the thickness of the surface boundary layer. Rotation of the workpiece is optional and not essential.

At step 106, ozone is injected into the fluid flow path 60 during the spray of water, or otherwise provided directly into the processing chamber 15. If the apparatus of FIG. 1 is used, the injection of the ozone preferably continues after the spray of water is shut off. If the workpiece surface begins to dry, a brief spray is preferably activated to replenish the liquid film on the workpiece surface. Processing time ranges from about 10 seconds to 15 minutes, depending on materials and other parameters, with typical times ranging from about 4-12, or 6-10 minutes.

Elevated temperature, or heated water or liquid here means temperatures above ambient or room temperature, that is temperatures above 20, 21, 25, 26, 30, 35 or 40° C. and up to about 99° C., for non-boiling/non-pressurized processes, or to about 200° C. in pressurized processes. Preferred temperature ranges are 21 or 26-99° C.; and 21 or 26-65° C. In the methods described, temperatures of 90-100° C., and preferably centering around 95° C., may be used. To avoid boiling at ambient pressures, temperature ranges of 21 or 26 to about 99° C. may be used.

After the workpiece 20 has been processed or cleaned, the workpiece 20 is optionally rinsed at step 108 and dried at step 110.

High ozone flow rates and concentrations can be used to produce faster cleaning or processing rates under various processing conditions including lower wafer rotational speeds and reduced temperatures. Use of lower temperatures, for example ambient temperatures ranging from for example 15-25° C., or above ambient temperatures such as 20, 21, 25, or 26-65° C. may be advantageous when still higher temperatures are undesirable. The concentration of the halogenated additive or HF ranges from about 1 part 49% HF (or halogenated additive) to 1-3,000 parts; 10-2,000 parts; 50-1,500 parts; 100-1,000 parts; 250-750 parts, or 400-600 parts DI water. Typical flow rates are about 300 ml/minute to 4 liters/minute; or 500 ml/minute to 1,000 ml/minute.

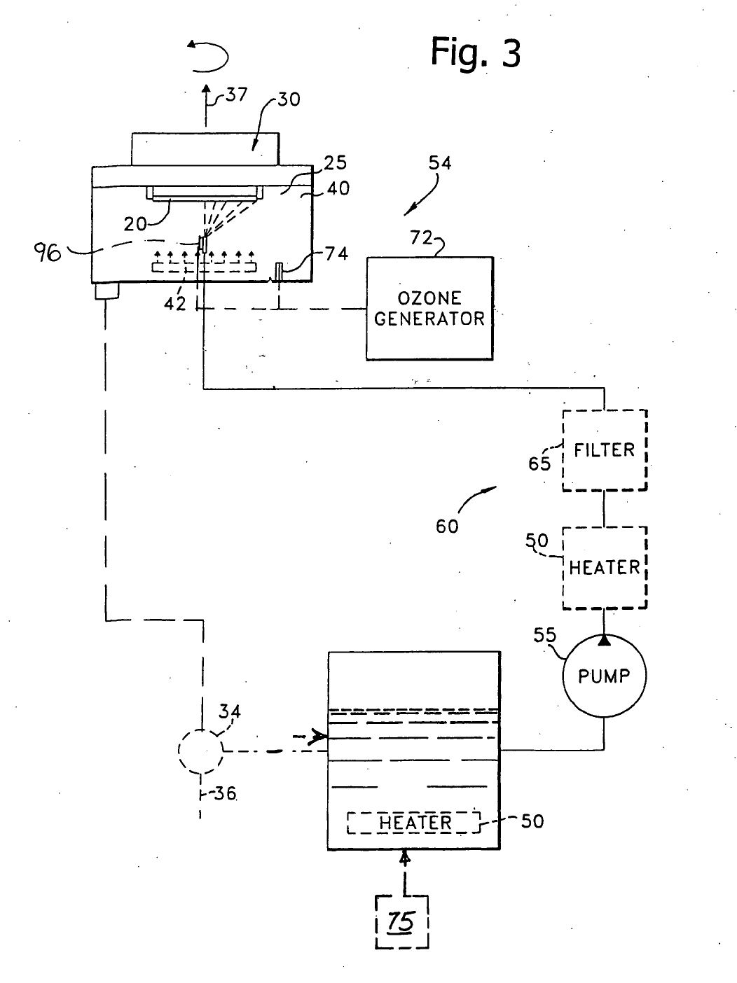

Turning to FIG. 3, in another ozone process system 54, one or more nozzles 74 or openings within the processing chamber 15 deliver ozone from ozone generator 72 directly into the chamber. Injection of ozone into the fluid path 60 is optional. As in FIG. 1, the ozone directly into the chamber from the ozone generator, into a fluid supply line, or into the reservoir, or a combination of them. The system of FIG. 3 is otherwise the same as the system of FIG. 1 described above.

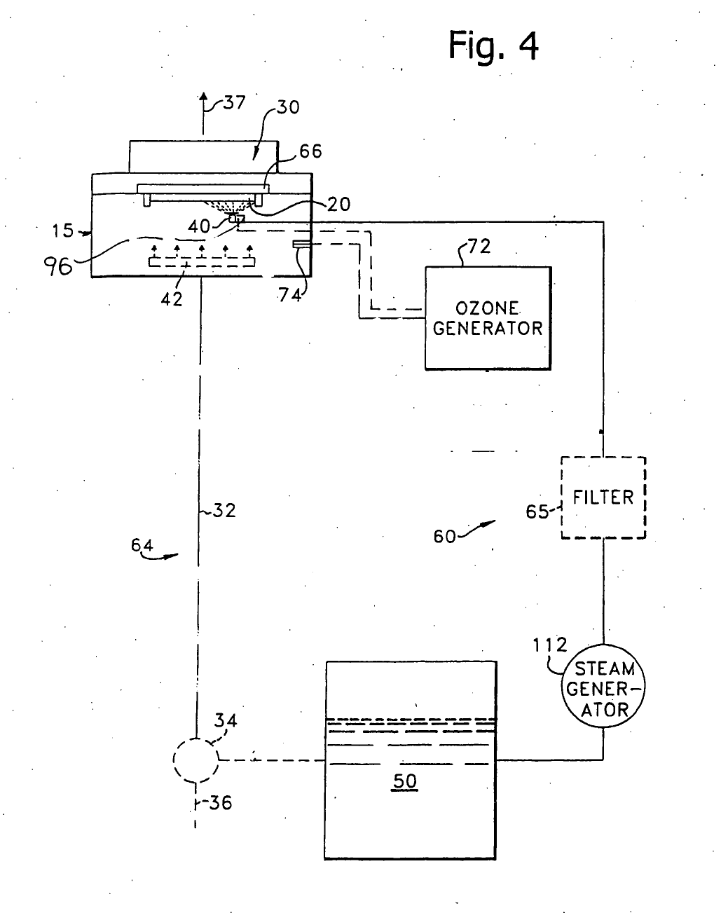

Referring to FIG. 4, in another ozone process system 64, a steam boiler 112 supplies steam including a halogenated additive into the processing chamber 15. The chamber 15 may be sealed to form a pressurized atmosphere around the workpiece 20. Alternatively, the processing chamber can be unsealed. Ozone gas may be directly injected into the processing chamber 15 as shown, and/or may be injected into steam supply pipe. With this design, workpiece surface temperatures can exceed 100° C., further accelerating the cleaning effect. While FIGS. 3 and 4 show the fluid and ozone delivered via separate nozzles 40, 74, they may also be delivered from the same nozzles, using appropriate valves.

A temperature-controlled surface or plate 66, as shown in FIG. 4, is advantageously in contact with the workpiece, to act as a heat sink, to maintain condensation of steam on the workpiece. Alternatively, a temperature-controlled stream of liquid (e.g., at 75 or 85-95° C.) is delivered to the back surface of a wafer 20, while steam and ozone are delivered to the process chamber and the steam condenses on the wafer surface. The wafer may be rotated to promote uniform distribution of the boundary layer, as well as helping to define the thickness of the boundary layer through centrifugal force. Rotation, however, is not a requirement.

The workpiece may be in any orientation during processing. The supply of liquid, gases, and/or steam may be continuous or pulsed. An ultra-violet or infrared lamp 42 is optionally used in any of the designs described above, to irradiate the surface of the workpiece 20 during processing, and enhance the chemical reactions, which remove the contamination. One of more of the spray nozzles 40 may be megasonic or ultrasonic spray nozzles 41.

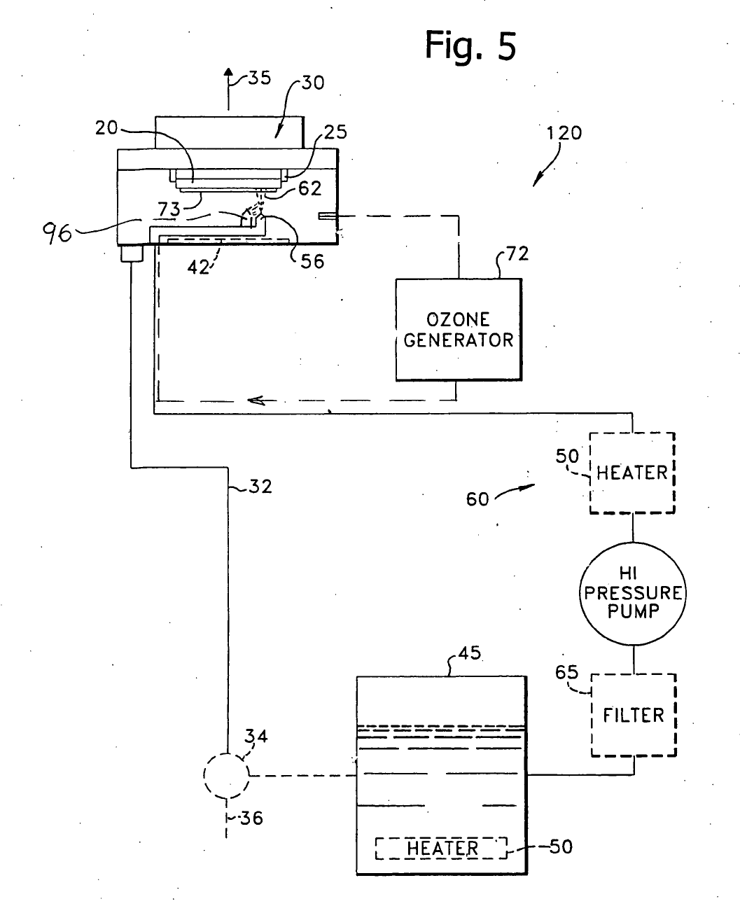

Referring to FIG. 5, another alternative system 120 is similar to the system 54 shown in FIG. 3, except that the system 120 does not use the spray nozzles 40. Rather one or more jet nozzles 56 are used to form a high pressure jet 62 of liquid. The liquid formed into the high pressure jet 62 penetrates through the boundary layer 73 of liquid on the workpiece surface and impinges on the workpiece surface with much more kinetic energy than in conventional water spray processes. The increased kinetic energy of the jet physically dislodges and removes contaminants. Unlike conventional fluid spray systems, few, if any, droplets are formed. Rather, a concentrated jet or moving column of liquid impacts on a small spot on the workpiece 20. In an immersion process, ozone is dissolved or bubbled into a bath of DI water and HF using concentrations and temperatures as described above.

In any of the non-immersion methods described above, and in any of the systems shown in any one of FIGS. 1-5, the ozone gas may also be separately jetted or sprayed onto the workpieces, from one or more separate gas jet or spray nozzles 96, adjacent to the liquid nozzle(s) 40, or concentric with the liquid nozzle(s). The ozone gas may also be entrained into the liquid spray or jet, in one or more combined liquid and gas entrainment nozzles, to enhance bulk transport of ozone gas to the workpieces.

The invention contemplates use of heated water including a halogenated additive such as HF, and ozone, regardless of how each of these elements is provided into the chamber. Halogenated additive means an additive including an element from Group 7 of the periodic table, i.e., F, Cl, Br, I or At.

### EXAMPLE I

A silicon wafer having a hardened residual layer of photoresist about 1200A-1500A thick and an underlying SLAM (Sacrificial Light Absorbing Layer) layer about 2500 thick was processed as described above. SLAM is one form of an ARC or anti-reflective coating. The wafer was rotated at 1000 rpm. A solution of 49% (weight) HF in de-ionized water was further diluted to a concentration within the range of 0.01 to about 1% (by weight). This solution was heated to 90° C. and sprayed onto the spinning wafer at a flow rate of 500-800 ml/minute. Ozone gas was delivered into the process chamber at about 10 slpm and a concentration of 240 g/m³. The process was performed for 8:00 minutes. The photoresist layer and the SLAM layer were both removed. There was no detectable attack of the carbon doped oxide (CDO) dielectric layer.

Other halogenated additives, especially fluorinated additives, may be used instead of HF, for example NH₄F. The ozone can be supplied dissolved in the water, co-injected with the water (with some ozone dissolving and rest entrained as bubbles of gas in the water), or the ozone can be delivered into the chamber separate from the water. Immersion techniques may also be used instead of spraying. With immersion, the workpiece is immersed in a bath of dilute HF and water. Ozone is dissolved in the water, and/or bubbled up through the water around the workpiece.

Thus, while several embodiments have been shown and described, various changes and substitutions may of course be made, without departing from the spirit and scope of the invention. The invention, therefore, should not be limited, except by the following claims, and their equivalents.

1. A method for cleaning or processing a workpiece, comprising in any order the steps of:
placing the workpiece into a process chamber;
applying a heated liquid including a halogenated additive onto the workpiece, with the heated liquid forming a layer on the workpiece;
controlling the thickness of the liquid layer on the workpiece, and introducing ozone gas into the process chamber, with ozone gas diffusing through the liquid layer and oxidizing a contaminant or film on the workpiece.

2. The method of claim 1 wherein the liquid comprises water and HF.

3. The method of claim 1 further including the step of heating the liquid to about 26-200° C.

4. The method of claim 1 with ozone gas entrained in the heated liquid and with entrained ozone contacting the workpiece via bulk transfer.

5. The method of claim 1 where the halogenated additive is gaseous HF injected into the liquid.

6. The method of claim 1 further comprising the step of controlling the thickness of the liquid by spinning the workpiece.

7. The method of claim 1 further comprising the step of controlling the thickness of the liquid by controlling the flow rate of the liquid onto the workpiece.

8. The method of claim 1 where the ozone is introduced into the chamber as a dry gas.

9. The method of claim 1 where the ozone is injected into the liquid before the liquid is introduced onto the workpiece.

10. The method of claim 1 wherein the liquid is sprayed onto the workpiece.

11. A method for removing an anti-reflective film from a surface of a workpiece, comprising in any order the steps of:
placing the workpiece into a process chamber;
rotating the workpiece;
applying a heated liquid including a halogenated additive onto the film on the surface of the workpiece, with the heated liquid forming a layer covering the film;
controlling the thickness of the liquid layer;
introducing ozone gas into the process chamber, with ozone gas diffusing through the liquid layer; and
removing the film from the surface of the workpiece via a chemical reaction between the HF in the water and the ozone.

12. The method of claim 11 wherein the ratio of HF to water ranges from 1:100 to 1:1000 parts.

13. The method of claim 11 further including the step of heating the liquid to about 26-200° C.

14. The method of claim 11 further including the step of heating the workpiece with a heater.

15. The method of claim 11 where the halogenated additive comprises gaseous HF injected into the liquid.

16. The method of claim 11 wherein the film comprises SLAM.

17. The method of claim 11 where the ozone is introduced into the chamber as a dry gas.

18. The method of claim 11 where the ozone is injected into the liquid before the liquid is introduced onto the workpiece.

19. The method of claim 1 1 wherein the liquid is sprayed onto the workpiece.

20. The method of claim 11 wherein the workpiece comprises a silicon wafer and the film comprises an ARC film.

21. The method of claim 11 wherein the workpiece comprises a carbon doped oxide dielectric layer under the an anti-reflective coating or film, and where the anti-reflective coating or film is removed without substantially damaging the doped carbon dielectric oxide layer.

22. A method for removing a film from a surface of a workpiece comprising in any order the steps of:
heating water containing a halogenated additive;
immersing the workpiece into a bath of the heated water;
introducing ozone gas into the heated water; and
removing the film or contaminant from the surface of the workpiece via a chemical reaction between the halogenated additive in the water and the ozone.

23. The method of claim 22 further including the step of bubbling ozone into the water around the workpiece.

24. The method of claim 22 further comprising the step of introducing sonic energy into the bath of water.

25. A system for removing anti-reflective coating from a workpiece, comprising in any order:
a process chamber;
a liquid source with the liquid containing water and a halogenated additive;
a heater for heating the liquid;
a fixture in the process chamber for holding one or more workpieces;
one or more spray nozzles in the chamber for spraying the liquid onto the workpiece.

26. A method for removing a film from a workpiece, comprising:
forming a heated liquid layer on a surface of the workpiece, with the liquid including a halogenated additive;
controlling the thickness of the liquid layer;
contacting the workpiece with steam; and
contacting the workpiece with ozone.
